(19) United States
(12) Patent Application Publication
(10) Pub. No.: US 2016/0210868 A1
(43) Pub. Date: Jul. 21, 2016

(54) INTEGRATED DEPARTURE AND ARRIVAL MANAGEMENT FOR AIRPORT RUNWAYS

(71) Applicant: Raytheon Company, Waltham, MA (US)

(72) Inventor: Timothy P. Donovan, Groton, MA (US)

(21) Appl. No.: 14/599,709

(22) Filed: Jan. 19, 2015

(51) Int. Cl. G08G 5/00; G08G 5/06

(52) U.S. Cl. CPC G08G 5/0043; G08G 5/0091; G08G 5/003; G08G 5/06

(57) ABSTRACT

A runway management software for assisting air traffic control personnel by returning an integrated runway schedule data item including both estimated arrival and departure times and estimated runways for both arrivals and departures of current active and future flights, and on a flight by flight basis. The information is provided in the form of the runway schedule data item which is generated by an algorithm included in the runway management software and coded to a non-transitory computer-readable medium. A system for returning the runway schedule data item includes the runway management software, the medium, and a processor for executing computer code of the software.

### FIELD OF THE INVENTION

The present invention relates generally to airport surface management software, and more particularly to software for managing arrivals and departures of aircraft, such as on a per flight basis.

### DESCRIPTION OF THE RELATED ART

Air traffic management facilities often use software to regulate arrivals of aircraft, and particularly airplanes, to an airport. For example, a traffic management specialist at a management facility may use conventional software to estimate arrival rates and to assign arrival times of aircraft arrivals to meet a predicted rate of arrival per unit of time, such as per hour. The arrival rates and times are typically estimated over relatively large time windows, such as 2 to 4 hours, based on historical statistics, such as historical arrival rates, for the forecast weather conditions.

The most important weather conditions affecting rates are typically wind direction and visibility. Wind direction is used to determine which runways are designated as active runways and affects the direction of takeoffs and landings because aircraft typically both takeoff and land into the wind to maximize lift. Visibility is affected by clouds, fog, precipitation, etc., and is often referred to in terms of runway visible range, also herein referred to as RVR. RVR is defined as the distance that an aircraft pilot can see along the runway.

Aircraft departing an airport are conventionally directed to queue at the departure end of the runway and takeoff during gaps in the arrival stream for the same or dependent runways. Thus a steady arrival stream may often cause a long departure queue as aircraft wait for gaps in the arrival stream, resulting in delay and excess fuel burn. Consequently, peaks and valleys in traffic develop causing continuous and lengthy arrival and departure queues, which are often coupled with insufficient time for air traffic management facilities to adequately respond to reduce the queues.

A typical air traffic management facility uses conventional software to regulate aircraft arrivals, and often includes a processor and/or a processing system for reading and executing processor-executable instructions contained in a computer-readable medium. The software may be used, for example, by an air traffic control tower, a terminal radar approach control facility, an air route traffic control center, or an air traffic control strategic command center.

### SUMMARY OF THE INVENTION

The present invention provides a unique runway management software for assisting air traffic control personnel by generating an integrated runway schedule data item that includes estimated arrival and departure times and estimated arrival and departure runways on a flight by flight basis with reference to a particular runway grouping, or set of runways. The data item may include data in any suitable form such as word documents, spreadsheets, data items such as data structures, etc. The runway management software considers numerous data items received various air traffic management facilities to provide a continuously updated runway schedule data item that is output by the runway management software. The output runway schedule data item includes information for airborne arriving aircraft under surveillance within a predetermined distance from the runway grouping and for non-airborne departing aircraft under surface surveillance on the runway grouping. The runway schedule data item also includes output information for arriving and departing aircraft scheduled to arrive/depart at the runway grouping within a predetermined time range from a time of initiation of generation of the runway schedule data item.

A system for generating the runway schedule data item includes a non-transitory computer-readable medium, data items encoded on the non-transitory computer-readable medium, computer code encoded on the non-transitory computer-readable medium, and processors for executing the computer code. The computer code includes the runway management software, which includes instructions coded to the non-transitory computer-readable medium and executed by the processor to generate the runway schedule data item.

According to one aspect, a system for generating a runway schedule data item stored on a non-transitory computer-readable medium, the system includes the non-transitory computer-readable medium, a processor configured to execute computer code stored on the non-transitory computer-readable medium, a flight plan data item received by the processor, a surface track data item received by the processor, a flight schedule data item received by the processor, and a surface-level weather observation data item received by the processor. The computer code includes an algorithm implementable to calculate estimated arrival and departure times of aircraft arriving and departing from a runway grouping, wherein the algorithm manipulates data stored within each of the flight plan data item, the surface tracks data item, the flight schedule data item, and the surface-level weather observation data item to return a runway schedule data item including a plurality of estimated arrival and departure times of aircraft arriving and departing from the runway grouping.

The system may further include a display screen communicatively connected to the processor and configured to display the runway schedule returned by the algorithm.

The algorithm may be configured to recalculate the estimated arrival and departure times a first plurality of times per minute.

The algorithm may be configured to return the runway schedule data item a second plurality of times per minute, and wherein the first plurality of times per minutes is greater than the second plurality of times per minute.

The system may further include an airport configuration data item and an airborne tracks data item received by the processor.

The algorithm may further return a data item including recommended arrival and departure runways and recommended taxi routes to and from the recommended runways.

The runway schedule data item may include plurality of estimated arrival and departure times of aircraft that are scheduled to arrive or depart within a time range extending a predetermined amount of time beyond a time of initiation of generation of the runway schedule data item.

According to another aspect, a system for sending to a prospective user a runway schedule data item including estimated arrival and departure times of aircraft arriving and departing from a runway grouping includes a non-transitory computer-readable medium, data items encoded on the non-transitory computer-readable medium, computer code encoded on the non-transitory computer-readable medium, and a processor executing the computer code. The data items include a flight plan data item, a surface track data item, and a flight schedule data item. The computer includes instructions coded to the non-transitory computer-readable medium and executed by the processor to generate the runway schedule data item. The instructions include for each arriving aircraft disposed within a predetermined distance of the runway grouping at the time of initiation of generation of the runway schedule data item, determining a recommended arrival runway and estimated time of arrival to a receiving gate disposed adjacent the runway grouping, and for each departing aircraft on the runway grouping at the time of the initiation of generation of the runway schedule data item, determining a recommended departure runway and estimated time of departure from the recommended departure runway.

The instructions of the computer code may further include for each aircraft scheduled to arrive at the runway grouping within four hours of the initiation of the generation of the runway schedule data item, and with exception to each arriving aircraft disposed within the predetermined distance of the runway grouping at the time of generation of the runway schedule data item, determining a recommended arrival runway and estimated time of arrival to a receiving gate disposed adjacent the runway grouping, and for each aircraft scheduled to depart from the runway grouping within four hours of the initiation of the generation of the runway schedule data item, and with exception to each departing aircraft on the runway grouping at the time of the initiation of the generation of the runway schedule data item, determining a recommended departure runway and estimated time of departure from a departing gate disposed adjacent the runway grouping.

The data items may further include an airport configuration data item, wherein the instructions of the computer code further include for each aircraft for which an estimated time of arrival or departure is generated, determining a taxi route from or to the runway grouping, respectively.

The data items may further include an airborne tracks data item, wherein the instructions of the computer code further include for each aircraft for which an estimated time of arrival is generated, determining if a reduction in speed instruction should be provided to the respective arriving aircraft.

The instructions of the computer code may further include for each aircraft for which an estimated time of departure is generated, determining the estimated queue delay time and target off block time.

The data items may further include an airport configuration data item, wherein the instructions of the computer code further include for each aircraft for which an estimated time of arrival is generated, recognizing when land and hold short operations are required.

The instructions of the computer code may further include for each aircraft for which an estimated time of departure is generated, determining whether the respective aircraft should hold at an edge of a runway of the runway grouping to avoid wake turbulence.

According to yet another aspect, a computer-readable medium having processor-executable instructions implementable to generate a runway schedule data item including estimated arrival and departure times of aircraft arriving and departing from a runway grouping has instructions including for each arriving aircraft within a predetermined distance from the runway grouping at the time of initiation of generation of the runway schedule data item (a) predicting an arrival runway, (b) calculating an estimated time of arrival, and (c) adjusting the estimated time of arrival for runway availability due to prior touch downs and/or take offs on and/or adjacent the predicted arrival runway. The instructions also include for each departing aircraft on the runway grouping at the time of the initiation of generation of the runway schedule data item (a) predicting a departure runway, (b) calculating an estimated time of departure, and (c) adjusting the estimated time of departure for runway availability due to prior touch downs and/or take offs on and/or adjacent the predicted departure runway.

The predetermined distance from the runway grouping may be 60 NM.

The instructions may further include for each aircraft scheduled to arrive at the runway grouping within four hours of the initiation of the generation of the runway schedule data item, and with exception to each arriving aircraft disposed within the predetermined distance of the runway grouping at the time of the initiation of the generation of the runway schedule data item, performing steps (a) through (c).

The instructions may further include for each aircraft scheduled to arrive at the runway grouping within four hours of the initiation of the generation of the runway schedule data item, and with exception to each departing aircraft on the runway grouping at the time of the initiation of the generation of the runway schedule data item, performing steps (d) through (f).

The instructions may further include receiving a flight plan data item, a surface tracks data item, and a flight schedule data item.

The instructions may further include displaying on a display screen the runway schedule data item, and updating the runway schedule data item a plurality of times per minute.

To the accomplishment of the foregoing and related ends, the invention comprises the features herein after fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1A is part of a schematic representation of an air traffic management system according to the invention.

FIG. 1B is another part of the schematic representation of the air traffic management system according to the invention.

FIG. 2 is a schematic representation of processor-executable instructions included in the system shown in FIGS. 1A and 1B and executed by a processor of FIGS. 1A and 1B.

FIG. 3 is another schematic representation of processor-executable instructions included in the system shown in FIGS. 1A and 1B.

FIG. 4 is yet another schematic representation of processor-executable instructions included in the system shown in FIGS. 1A and 1B.

FIG. 5 is still another schematic representation of processor-executable instructions included in the system shown in FIGS. 1A and 1B.

FIG. 6 is another schematic representation of processor-executable instructions included in the system shown in FIGS. 1A and 1B.

FIG. 7 is yet another schematic representation of processor-executable instructions included in the system shown in FIGS. 1A and 1B.

FIG. 8 is still another schematic representation of processor-executable instructions included in the system shown in FIGS. 1A and 1B.

FIG. 9 is another schematic representation of processor-executable instructions included in the system shown in FIGS. 1A and 1B.

FIG. 10 is yet another schematic representation of processor-executable instructions included in the system shown in FIGS. 1A and 1B.

FIG. 11 is still another schematic representation of processor-executable instructions included in the system shown in FIGS. 1A and 1B.

### DETAILED DESCRIPTION

An integrated runway management software program is configured for storage in a non-transitory computer-readable medium and is configured to function in conjunction with one or more air traffic information and control facilities, also herein referred to as information and control facilities. The runway management software program, also herein referred to as the software program or runway program, assists a user, such as an air traffic control person for example, with planning and monitoring aircraft arrivals and departures with regards to one or more runways of a runway grouping.

The runway management software is configured to return an integrated runway schedule data item that includes, for example, estimated runway assignments with estimated arrival and departure times. The information and control facilities include, for example, air traffic control towers, terminal radar approach control facilities, air route traffic control centers, and the air traffic control strategic command center to be explained further. The runway schedule data item is generated with respect to a particular runway grouping, which is a set of one or more runways located at one or more aircraft facilities, such as commercial airports or non-commercial airports.

While the description detailed herein is described in conjunction with one or more commercial runways of a single airport having commercial planes departing and arriving, the software program herein described may be also utilized with numerous airports or other aircraft facilities concurrently, such as with non-commercial runways or airports. The software program may be additionally or alternatively used with numerous types of aircraft, such as commercial planes, cargo planes, fighter jets, other planes, helicopters, drones, etc.

For example, the runway program may assist controlling personnel at an air traffic control tower (ATCT) of an airport having numerous parallel and crossing runways by identifying designated runways for takeoff and landing, while analyzing and manipulating information including surface wind, surface visibility, airport configuration, aircraft type, aircraft speed, aircraft heading, predicted times of arrival and departure, airline flight schedules, taxi routes and time, etc. As another example, personnel at a terminal radar approach control facility (TRACON) overseeing numerous airports each having one or more runways may use the information to provide aircraft headings and speeds for aircraft traveling to and from the numerous airports.

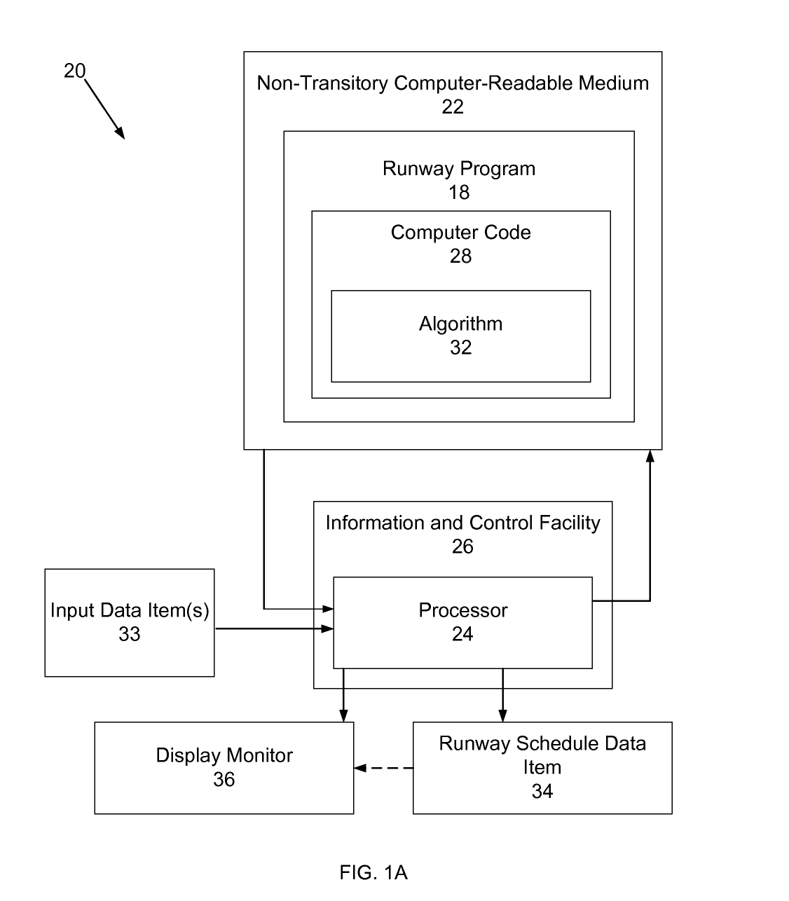

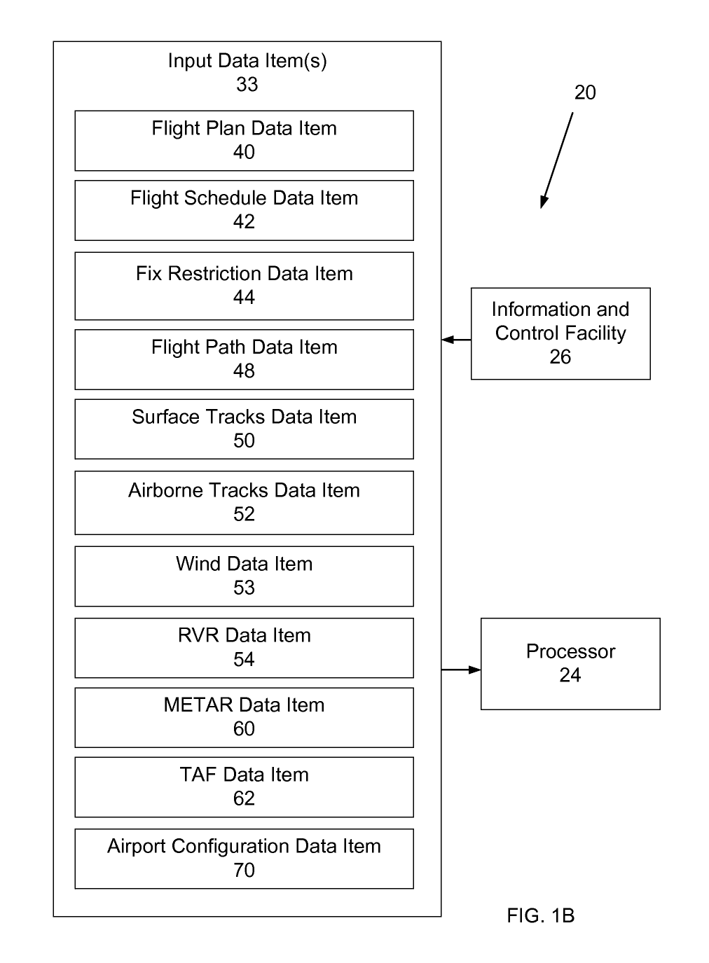

An exemplary runway management software program 18 according to the invention may be included in a data item generating system, and more particularly an air traffic management system 20 according to the invention, also herein referred to as a system 20, and as shown schematically in FIGS. 1A and 1B. The system 20 includes a non-transitory computer-readable medium 22. The medium 22 is capable of storing the runway management software program 18, also referred to as a runway program 18 or software program 18.

The runway program 18 includes various computer codes, such as computer code 28 including instructions, which include an algorithm 32, for generating data items that are readable by a processor 24 of the system 20. The instructions/algorithm 32 are implementable to calculate arrival and departure times of aircraft arriving and departing from a runway grouping and to provide this data in the form of a runway schedule data item 34 output from the processor 24.

The processor 24 may be a suitable computer communicatively connected to the medium 22, and is configured to execute the computer code 28 stored on the non-transitory computer-readable medium 22. For example, the processor 24 may be stored at any facility communicatively connected to a management facility 26, which may include, for example, air traffic control towers, terminal radar approach control facilities, and air route traffic control centers. These management facilities 26 organize and control arrivals and departures from one or more runways of one or more airports or other similar aircraft landing/departing facilities. Thus, the processor 24 may be disposed at one of the facilities or at any other location that is communicatively connected, such as wirelessly, to a respective management facility 26.

The runway schedule data item 34 may be communicated to and displayed on an suitable screen, such as a display monitor. The display monitor may be a monitor 36 of the system 20, that is communicatively connected to the processor 24 and configured to display the runway schedule data item 34 returned by the runway program 18. For example, the display monitor 36 may be part of a tablet computer, portable computer, desktop computer, phone, or any other suitable device.

Generally, the runway program 18, and thus the algorithm 32 contained therein, analyzes one or more input data items 33 and outputs at least the runway schedule data item 34. As used herein, a data item is a set of organized data. The data may be organized in one or more of a list, a matrix, a linked set, etc. The runway program 18 includes one or more sets of instructions/algorithms 32 for manipulating the input data items 33, analyzing the data organized in the data items, and forming and returning the output runway schedule data item 34.

The runway schedule data item 34 includes at least an estimated runway and a revised estimated time of arrival (ETA) for each aircraft presently within a predetermined distance of its predicted runway or an estimated time of departure (ETD) for each aircraft presently on the runway grouping. The runway schedule data item 34 also includes the same or similar information for aircraft that are scheduled to arrive or depart within a suitable predetermined time window, such as up to two hours or four hours from the time of initiation of generation of the runway schedule data item 34. In some embodiments, the predetermined distance may be any suitable distance such as approximately 100 NM (nautical miles), or more preferably approximately 60 NM. Initiation of generation of the runway schedule data item 34 is defined, for example, as when the processor 24 performs the first step or instruction of the algorithm 32.

The one or more input data items 33 manipulated and analyzed to generate the runway schedule data item 34 are provided by one or more of the management facilities 26 that utilize and/or receive the returned runway schedule data item 34. The information control facilities 26 may each send one or more of the input data items 33 which are received by the processor 24. The processor 24 may be appropriately configured to receive the input data items 33, which may be sent in series or in parallel, and which each may be sent one or more times per minute to maintain an up-to-date archive of data from which the runway schedule data item 34 may be generated.

One or more the below-described exemplary management facilities 26 may provide, such as send, each of the input data items 33. Accordingly, the system 20 may include one or more of the input data items 33, each of which may be received by the system 20 and manipulated by the runway software program 18 to generate the runway schedule data item 34. The input data items 33 may be communicated to the system 20, such as to the processor 24, via wired communication, wireless communication, or a combination thereof.

In the exemplary embodiment, specific of the exemplary facilities 26 provide specific of the input data items 33, as will be explained. Though in other embodiments, each of the requisite input data items 33 may be received by the system 20 from any suitable management facility 26, or even from any other suitable location capable of providing the respective input data item(s) 33.

One or more runway schedule data items 34 may be generated from the input data items 33. In the case that multiple runway schedule data items 34 are generated, the structures 34 may include different data, such as being customized for a particular runway or runway grouping.

Additionally or alternatively, the runway program 18 is configured to generate the runway schedule data item 34 one or more times per minute, such as approximately every 15 seconds, or more preferably approximately every 10 seconds. After generation of the first runway schedule data item 34, the runway program 18 may be configured to generate subsequent and updated runway schedule data items 34, or merely to update the first runway schedule data item 34.

The runway program 18 is also configured to send out the runway schedule data item 34 to one or more respective management facilities 26 a set number of times per minute, such as approximately every 30 seconds, and more preferably approximately every 15 seconds. The number of times per minute that the data items 34 are returned to the facilities 26 is preferably less than the number of times per minute the processor 24 receives the input data items 33. In this way, control personnel at the one or more respective management facilities 26 may be less overwhelmed by the amount of incoming data received, while the program 18 is provided with continuous updates, and thus more data points, to more accurately predict and provide the output runway schedule data of the runway schedule data item 34. In some embodiments, some of the one or more respective management facilities 26 may receive a respective runway data item 34 more frequently than another one or more other of the respective information control facilities 26.

One exemplary management facility 26 is an air traffic control tower, or ATCT. The tower is often provided at each aircraft facility, such as with one or more being located at each airport. The ATCT typically controls aircraft within 8 NM and approximately 1,000 feet of the surface, and on the surface, i.e. on the runway grouping. It is noted that while there is a distinction between aircraft on the runway grouping and aircraft off the runway grouping, such as aircraft sitting at a gate, the ATCT also often controls aircraft off the runway grouping.

Another exemplary facility 26 may be a TRACON (terminal radar approach control facility). These facilities are often regional and control numerous airports located within a predetermined distance of the primary airport for the TRACON. This type of facility typically controls airspace above multiple airports, and more preferably controls airspace from 1000 feet to approximately 10,000 to 20,000 feet of the surface and within approximately 40 to 60 miles, such as within approximately 50 miles, from a primary airport of the multiple airports.

An air route traffic control center, also herein referred to as an ARTCC, is yet another exemplary facility 26. There are approximately 22 U.S. ARTCCs, for example, which are dispersed throughout the United States and provide regional coordination of numerous TRACONs. A typical ARTCC provides control of airborne aircraft en route from/to the runway groupings overseen by respective TRACONs and/or ATCTs. For example, this control may not be based on location of the respective ARTCC, but instead based on the distance of each aircraft from its designated runway grouping, such as within 500 miles of its designated runway grouping.

In the United States, a single air traffic control system command center, or ATCSCC, manages flow of all airborne aircraft, such as airplanes. This center manages by exception by providing restrictions, such as with regards to headings, speeds, distances between aircraft, etc., which are usually made in response to weather conditions.

Each airline, commercial or otherwise, typically has a national flight operation center, or FOC. This center controls all flights, flight schedules, etc., for all aircraft and flights flying under the name of the airline and/or its affiliates and/or subsidiaries.

Additionally, many airports, and other facilities from which aircraft takeoff and land, include airport surface detection equipment, also called ASDE-X, surface tracks, or surface surveillance. This equipment uses radar to provide the current surface position of each aircraft, such as by monitoring aircraft transponders. In some embodiments, the ASDE-X is integrated with the local ATCT. In addition to this surface tracking, an airport often includes air search radar (ASR) equipment for similarly monitoring airborne aircraft, also called airborne tracks or airborne surveillance.

Finally, most airports also include an automated weather observation station, or AWOS. The AWOS measures and provides information with regards to weather, such as wind, precipitation, moisture, and visibility on the ground, i.e., on the surface.

The one or more input data items 33 that may be received into the system 20, such as by the processor 24, from the one or more facilities 26 includes a flight plan data item 40. The flight plan data item 40 includes data with respect to an aircraft's travel through the skies. The exemplary flight plan data item 40 includes altitude, speed, and route information such as fixes, and may be provided to the system 20 by a TRACON (terminal radar approach control facility), for example.

This information is useful in maintaining non-interaction between airborne aircraft and in planning proposed runways and arrival/departure timing. Information with respect to a particular flight is typically provided to the respective pilot(s) prior to departing a runway grouping, and also may be modified anytime during flight. For example, when an aircraft crosses from a first sector controlled by a first facility 26 to a second sector controlled by a second facility 26, the second facility 26 may provide modified altitude, speed, and route information to the aircraft.

A flight schedule data item 42 includes data with respect to timing and aircraft type for each flight. The flight schedule data item 42 is typically provided by each airline's FOC (flight operation center), for example. The exemplary flight schedule data item 42 includes plane type and size, which are useful in determining the distance required between successive arrivals or departures due to wake turbulence. An aircraft's wake can affect timing for subsequent movements on the same and adjacent runways of a runway grouping, requiring added distance and/or time be placed between movements of the respective aircraft and other aircraft to prevent accidents, for example.

The exemplary flight schedule data item 42 also includes predicted times of arrival to or departure from a gate, the particular gate used for each flight, and the predicted time a departing flight leaves the gate to enter the runway grouping and begin taxiing (called OBT or off block time, and also herein referred to as a push time). This information is particularly useful in reducing queue delay of departing planes. Queue delay is defined as the delay of a departing aircraft as it waits, often physically in a line with other aircraft, for until it is their turn to use the departing runway. Note that the term “predicted” is herein used with respect to information provided as an input to the system 20, while the term “estimated” is herein used with respect to information output from the system 20, and thus returned by the runway software program 18.

Another input data item 33 that may be received by the system 20 is a fix restriction data item 44. The fix restriction data item 44 is often provided by a TRACON and includes information regarding proximity restrictions for airborne aircraft. For example, the exemplary fix restriction data item 44 includes restrictions on distances between aircraft, or alternatively, restrictions on timing between aircraft trailing one another.

A flight path data item 48 also is often provided by the ATCSCC. This data item 48 includes headings and paths for flights within a particular area, such as an area around the respective TRACON, such as 60 NM, for example. Each flight path may include one or more flight segments, each of which starts at a start vertex and ends at an end vertex, which is often integral with the start vertex of a next segment. Each vertex includes a respective latitude and longitude. The flight path data item 48 may also include distances and proposed speeds for each flight segment, and/or may be integrated with the flight plan data item 40.

Two tracks data items, a surface tracks data item 50 and an airborne tracks data item 52, include information with respect to location, such as GPS location, of respective aircraft in the sky and on the ground. These data items 50 and 52 provide live positions of aircraft. The surface tracks data item 50 is often provided by the ASDE-X (airport surface detection system) using radar that is updated approximately each second, for example. The airborne tracks data item 52 is often provided by a TRACON, as previously mentioned, and is updated approximately once every five seconds. Aircraft may be monitored both in the air and on the surface using their respective transponder location.

Numerous weather observation data items also may be provided to the system 20, including a wind data item 53, a runway visibility range (RVR) data item 54, an aviation weather observation ( ) data item 60, and a terminal area forecast (TAF) data item 62. The wind data item 53 includes information such as wind speed, direction, and consistency on the surface of the respective runway grouping, while the RVR data item 54 includes visibility range information also on the surface of the respective runway grouping. Both of these exemplary data items 53 and 54 are provided by the AWOS (automated weather observation station). One or both of the data items 53 or 54 may also include surface precipitation and/or moisture information.

The METAR data item 60 provides basic weather observations for the runway grouping, such as precipitation, temperature, and wind, both on the surface and in the sky. The exemplary METAR data item 60 is provided by the AWOS and is updated approximately every hour. Likewise, the TAF data item 62 is also updated approximately every hour, but provides a forecast for the runway grouping. The TAF data item 62 is provided by the ATCSCC (air traffic control system command center) and may include information obtained from the national weather service (NWS), for example.

Also included in the input data items 33 is an airport configuration data item 70 which includes a large amount of information. Included is runway configuration, such as which runways are designated for arrival and which are designated for takeoff based on wind direction, whether runways cross one another, required distances to keep between certain sized aircraft, and recommended taxi routes along the runway grouping based on the target runway or based on aircraft size. The airport configuration data item 70 also includes the heading direction of each runway, whether or not adjacent arrival and departure runways affect one another in terms of aircraft wake, and whether or not a runway may be used for both arrivals and departures.

Further included in the airport configuration data item 70 may be the departure fix for aircraft landing or taking off from a particular runway and the maximum aircraft size that a runway can accommodate. Also included are runways which are used during low or extremely low visibility occurring on the runways and/or when to utilize an instrument approach rather than a visual approach on a particular runway based on a particular visibility. This data is provided in the form of one or more integrated tables sent to the system 20.

The airport configuration data item 70 is provided by the respective ATCT (air traffic control tower) presiding over the respective runway grouping and includes the large quantity of information to efficiently monitor the numerous and different concerns that affect different runway groupings. Accurately analyzing these runway grouping characteristics provided in the airport configuration data item 70 provides the benefit of returning accurate estimate times of arrival and departure and respective estimated runways.

Many of these concerns are categorized as runway occupancy concerns. For example, an arrival runway disposed adjacent a departure runway may require departure times on the departure runway to be coordinated with arrival times on the separate arrival runway due to aircraft wake concerns. Similarly, this concern is even more relevant when a single runway is alternately utilized for both arrivals and departures. Runways crossing one another require even greater coordination because additional procedures must be implemented for aircraft using at least one runway of the pair of crossing runways. For example, one aircraft may land and hold short, meaning that it will not cross the intersection of the pair of crossing runways until an aircraft on the other of the pair of crossing runways reaches a particular location on the runway or a predetermined amount of time has passed since touch down on the other of the pair of crossing runways.

It will be appreciated that with respect to the plurality of input data items 33 herein described, in other embodiments, each input data item 33 may be provided by any suitable management facility 26 to the system 20.

The input data items 33 may also be manipulated to provide additional information in the exemplary runway schedule data item 34 output from the processor 24. For example, estimated taxi routes, taxi time durations, queue delay time durations, and secondary estimated runways may be provided. The runway schedule data item 34 may include increases or decreases in estimated arrival/departure times based on the occurrence of estimated arrivals/departures on the same runway, or on adjacent or crossing runways. A LAHSO (land and hold short) operation may be designated for one or more aircraft using crossing runways. Target off block times may be provided to reduce time of departure flights in queue delay. Likewise, arrival flights may be provided with requirements to increase or decrease approach speeds, also to reduce congestion on the respective runway grouping. Estimated runways may be continuously changed during runway schedule data item updates to account for a crowded arrival time duration or changes in weather, for example. A landing or departure via instrument control may be recommended if runway visibility range is low.

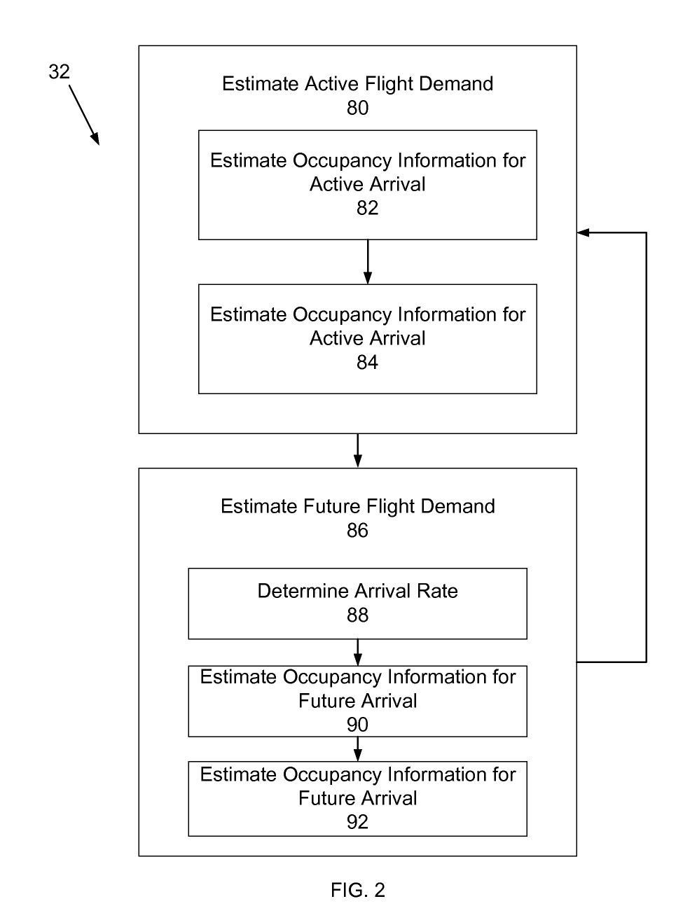

The runway management software program 18 according to the invention includes a unique set of processor-executable instructions, exemplified as the algorithm 32, for returning the runway schedule data item 34. The processor-executable instructions output by the software program 18 may be best appreciated with reference to the flow diagrams of FIGS. 2 to 11, which for purposes of simplicity of explanation are shown and described as a series of blocks. The methodologies are not limited by the order of the blocks, as some blocks can occur in different orders or concurrently with other blocks from that shown or described, such as in parallel or in series with other blocks. Moreover, less than all the illustrated blocks may be required to implement an example methodology. Furthermore, additional or alternative methodologies can employ additional, non-illustrated blocks.

As used herein, software includes but is not limited to, one or more computer or processor instructions that can be read, interpreted, compiled, and/or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or computer-executable instructions can be located in one logic or distributed between two or more communicating, co-operating, or parallel processing logics and thus can be loaded or executed in series, parallel, massively parallel and/or other manners.

The runway software 18 is executed by, such as stored in, read, and run by, the non-transitory computer-readable medium 22, or alternatively by any suitable computer-readable medium, which herein refers to any suitable medium that participates in directly or indirectly providing signals, instructions, or data. The computer-readable medium 22 may take forms, including, but not limited to, non-volatile media, volatile media, and/or transmission media.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object-oriented or artificial intelligence techniques.

Turning now to FIG. 2, in general, the processor-executable instructions of the algorithm 32 coded to the non-transitory computer-readable medium 22 (FIGS. 1A and 1B) and executed by the processor 24 include analysis of data related to both current and future, arrivals and departures from the respective runway grouping. In this way, the output runway schedule data item 34, includes (a) an estimated runway and a revised estimated time of arrival (ETA) or estimated time of departure (ETD) for each aircraft presently airborne and within a predetermined distance of its predicted runway or presently on the runway grouping, respectively, and (b) the same or similar information for aircraft that are scheduled to arrive or depart within a suitable predetermined time window from the time of initiation of generation of the runway schedule data item 34, as previously mentioned.

By analyzing and providing data for both arrivals and departures, the algorithm 32, and thus the runway software program 18, is capable of providing more accurate runway schedules than conventional programs. Conventional programs typically analyze and return only arrival data, while departures are fit into suitable empty time slots between arrivals touching down on or near departure runways. Conventional programs also typically analyze and provide runway-related data in aggregate over periods of time, such as two to four hours. In such case, aggregate historical data is utilized to predict arrival runways and estimated arrival rates.

On the other hand, the runway software program 18 is capable of analyzing numerous up-to-date data input data items 33 that are received into the system 20. The program 18 then returns runway-related data per flight, rather than merely in aggregate. Additionally, the runway program 18 outputs and continuously updates data with regards to both current and future arrivals and departures, providing a fully integrated runway schedule outlook for air traffic personnel. Accordingly, the runway program 18 enables air traffic personnel to more efficiently control arrivals and departures to and from the respective runway grouping.

For example, the runway program 18 may provide accurate arrival and departure times, and these times may be updated a plurality of times per minute, as mentioned. The accurate times, in combination with providing the most appropriate runway, enable departing planes to spend less time in a departure queue in a taxi lane awaiting an allowed time to approach a departing runway and/or awaiting an opportunity to use a runway as a departing runway due to arrivals. Departing planes and their crew will be better prepared to capitalize on time slots and available runways for departures that develop between arrivals. As a result, less fuel will be wasted, passengers will be provided with more accurate timing, and airlines and facilities may spend less on overhead and staff/grounds crew.

Turning again to FIG. 2, and starting at block 80, the current or active flight demand is estimated, including estimating occupancy information for each active arrival (block 82) and estimating occupancy information for each active departure (block 84). The goal of these steps is to account for all arriving and departing flights that are under surveillance, such as via radar surveillance at one or more of the management facilities 26. For each of these flights under surveillance, additional goals are to predict the runway assigned, predict time of arrival to that runway, the occupancy for that runway, and impact on all other dependent runways on a flight by flight basis.

In general, there is little opportunity to adjust the timing of arrivals within terminal airspace, and once departures are taxiing the departure runway is already assigned. Departures will wait in the corresponding departure queue for a gap in the arrival stream and then behind previous departures for wake turbulence separation. Thus, these steps also determine the time window for runway occupancy for all active arrival flights and the delay anticipated for each departure, as well as the aggregate and average delay for each departure queue.

Next, at block 86, the future flight demand is estimated, including determining the maximum arrival rate for each runway in the associated runway grouping (block 88), estimating occupancy information for each planned arrival that is scheduled within a predetermined time window (block 90), and estimating occupancy information for each future departure that is scheduled within the same predetermined time window (block 92). The goal of these steps is to identify runway occupancy from future arrivals and departures scheduled for a predetermined time window, such as the next two hours, after initiation of the current loop of the algorithm 32.

For each such flight, the algorithm 32 will recommend the runway and default taxi route and duration, and then identify occupancy for that runway and other runways in the runway grouping. Arrival times for future flights may be adjusted to create gaps for departures, and the resulting target ETA of each flight is provided as an output so that the flight may be slowed or accelerated in terminal and/or in enroute airspace. In summary, these steps determine the time window for runway occupancy for all planned flights in the predetermined time window and the delay anticipated for each planned departure in the predetermined time window, as well as the aggregate and average delay for each associated departure queue.

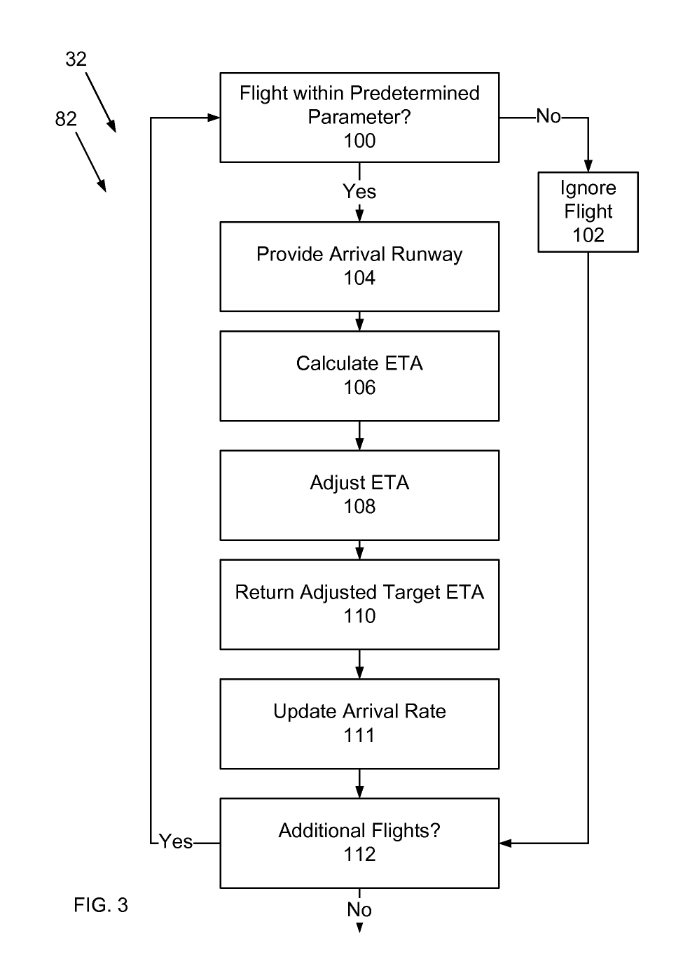

Turning next to FIG. 3, a process for estimating occupancy information for each active arrival (block 82, FIG. 2) is depicted as various sub-processes. The process 82 begins with a decision block 100 to determine whether a flight is within a predetermined distance such as to be classified as an active arriving flight. The algorithm 32 may use one or more of the flight schedule data item 42, the flight path data item 48 and the airborne tracks data item 52 to identify aircraft which may be within the predetermined distance. The predetermined distance may be determined by the software or continuously changed by a user. For example, the predetermined distance may be 80 NM from the associated runway grouping, or more preferably, 60 NM from the associated runway grouping.

The process 82 cycles through each such identified flight, closest first, one at a time. If a flight is not within the predetermined distance or altitude, the algorithm 32 moves to block 102 to classify the flight with an “IGNORE” classification. The algorithm 32 then moves to decision block 112 to determine if there are additional active arriving flights to analyze. On the other hand, if the currently analyzed flight is within the predetermined distance, the algorithm 32 moves to provide an estimated arrival runway (block 104), calculate the estimated time of arrival (ETA) (block 106), adjust the ETA (block 108) such as based upon the airport configuration data item 70, and then return the adjusted target ETA (block 110), each of which is further described. Finally, the arrival rate for the respective runway is updated at block 111. The arrival rate is the number of arrivals per unit of time that arrive on a runway. Next, the algorithm 32 again moves to decision block 112 to determine if there are additional active arriving flights to analyze.

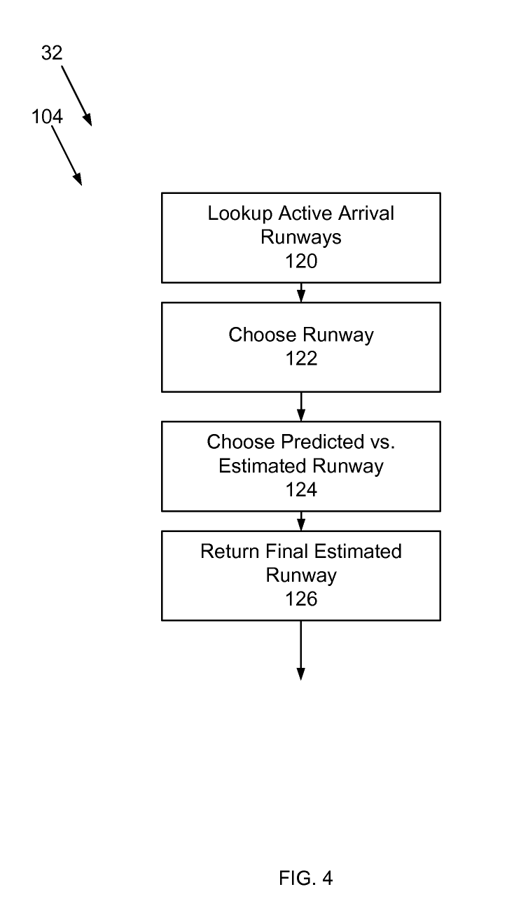

Moving to FIG. 4, the block 104 for estimating the arrival runway is further described. First the algorithm 32 looks up active arrival runways (block 120) using the airport configuration data item 70. Thus the algorithm 32 analyzes positioning of runways relative to one another, including whether there are crossing runways and runways used for both arrivals and departures, for example. The most viable runway is chosen at block 122, which utilizes one or more of the flight schedule data item 42, surface tracks data item 50, the wind data item 53, and the runway visibility range (RVR) data item 54. Thus, the algorithm 32 analyzes aircraft size, visibility, wind, precipitation, and positions of other aircraft. The most viable runway may be the closest runway based on the current fix of the arriving aircraft, requiring use of the airborne tracks data item 52.

At block 124 the most viable runway, such as the closest runway, is chosen between (a) the runway returned by block 122 and (b) the predicted runway. The predicted runway may be provided by the flight schedule data item 42. The final chosen runway is output as the estimated arrival runway at block 126.

In FIG. 3, The block 106 for calculating the ETA begins with a calculation of the duration on approach of each flight segment from an aircraft's current position or arrival fix to the runway grouping threshold using the estimated arrival runway provided in block 126. The calculation assumes an array of flight segments are provided from the current position to the runway threshold. The distance to the next start vertex, headwind, and heading are used as inputs to this calculation, which returns a time duration until landing. These inputs may be manipulated from one or more of the flight path data item 48, including flight paths, and one or more of the weather data items 60 and 62, including wind and other weather data. The estimated time of arrival output from this step is the sum of the time durations of each flight segment.

Block 108 for adjusting the ETA adjusts this ETA output from block 106 by manipulating additional data. This calculation adjusts ETA to account for arrivals on the same runway and for arrivals and/or departures on close parallels or crossing runways, in addition to accounting for same runway separation and wake turbulence separation for successive arrivals.

The additional data includes the ETA's of other active flights already output by the algorithm 32. Also used is the flight schedule data item 42, including aircraft sizes affecting trailing limitations due to wake, and the airport configuration data item 70, including the layout of the runway grouping. In general, block 108 adjusts an arrival aircraft/flight's ETA for runway occupancy from a previous arrival already determined by the algorithm 32. For example, when a following aircraft touches down on a runway prior to the preceding aircraft clearing the same runway, the following aircraft is slowed by approach and local controllers to maintain separation.

When the algorithm 32 returns the adjusted target ETA at block 110, the returned ETA is added to the runway schedule data item 34 and also added as an input for later steps. Additionally, the arrival rate for the respective runway used for the respective arriving flight is adjusted to account for and to include the respective arrival (block 111).

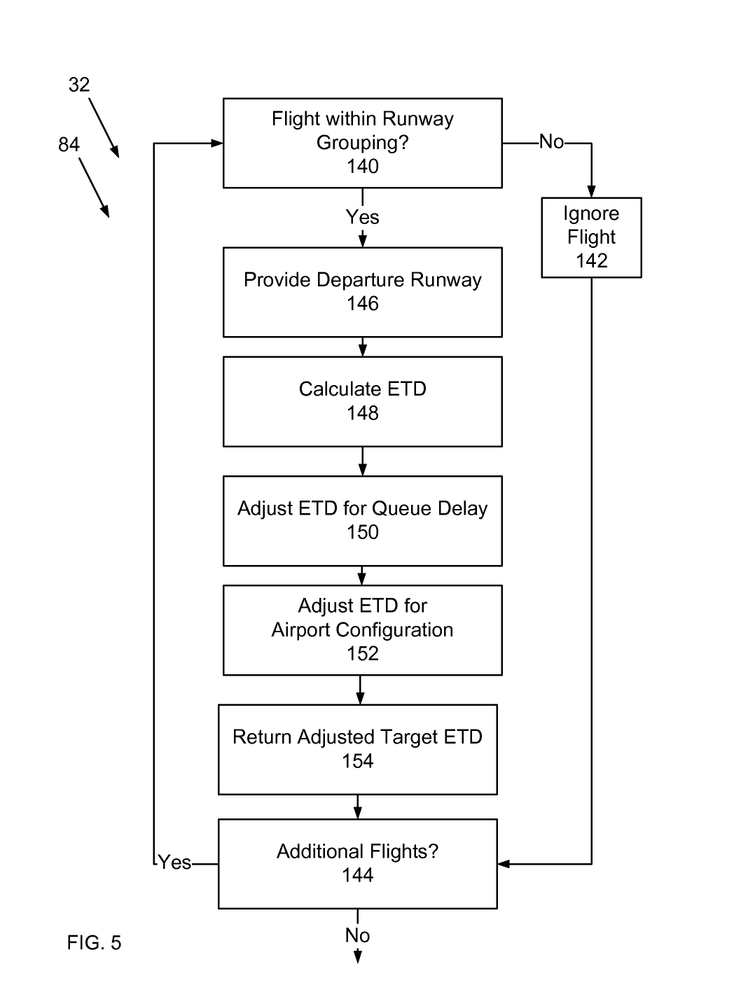

Referring next to FIG. 5, the algorithm 32 begins the process of block 84, estimating occupancy information for each departure flight. The process 84 begins with a sub-process block 140 to determine whether a flight/aircraft is on the surface of the runway grouping, and to classify such flight/aircraft as an active departing flight. The algorithm 32 may manipulate one or both of the flight schedule data item 42 and the surface tracks data item 50 to identify aircraft which may be active departing flights located on the area defined by the airport configuration data item 70 as runway.

The process 84 cycles through each such identified flight, closest first. If a flight is not within runway grouping, the algorithm 32 moves to block 142 to classify the flight with an “IGNORE” classification. The algorithm 32 then moves to decision block 144 to determine if there are additional active departing flights to analyze. On the other hand, if the currently analyzed flight is on the surface of the runway grouping, the algorithm 32 moves to provide an estimated departure runway (block 146), calculate the estimated time of departure (ETD) (block 148), adjust the ETD for queue delay (block 150), adjust the ETD for airport configuration (block 152) such as based upon the airport configuration data item 70, and then return the adjusted target ETA (block 154), each of which is further described. Next, the algorithm 32 again moves to decision block 144 to determine if there are additional active departing flight to analyze.

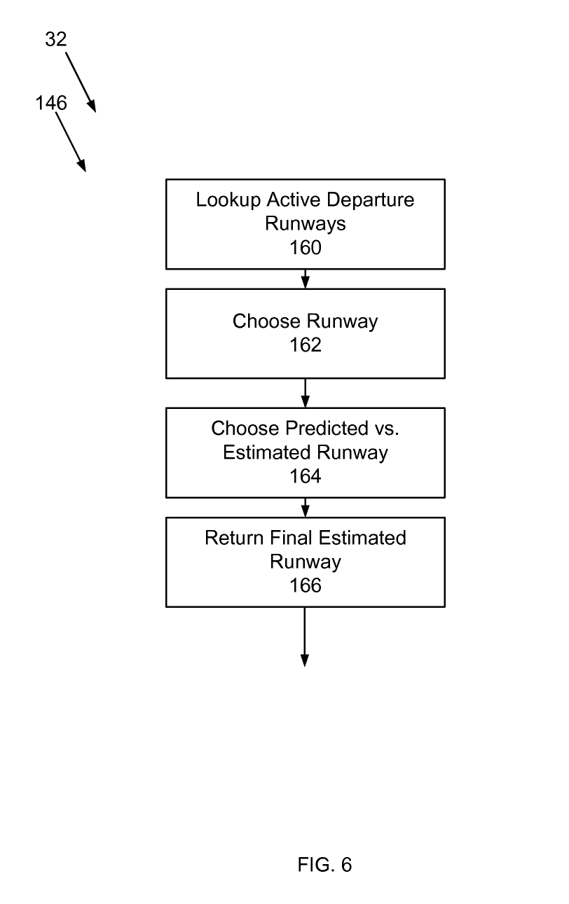

Moving to FIG. 6, the block 146 for estimating the departing runway is further described. First the algorithm 32 looks up active departing runways (block 160) using the airport configuration data item 70. Thus the algorithm 32 analyzes positioning of runways relative to one another, including whether there are crossing runways and runways used for both arrivals and departures, for example. The most viable runway is chosen at block 162, which utilizes one or more of the flight schedule data item 42, surface tracks data item 50, the wind data item 53, and the runway visibility range (RVR) data item 54. Thus, the algorithm analyzes aircraft size, visibility, wind, precipitation, and positions of other aircraft. The most viable runway may be the closest runway based on the predicted taxi route, which may be included in one or more of the flight schedule data item 42 or airport configuration data item 70.

At block 164 the most viable runway, such as the closest runway to the taxi route, is chosen between (a) the runway returned by block 162 and (b) the predicted runway. The predicted runway may be provided by the flight schedule data item 42. The final chosen runway is output as the estimated departure runway at block 166.

The block 148 for calculating the ETD begins with a calculation of the taxi duration from the aircraft's current position to its estimated runway provided at block 164. The taxi route is composed of runway segments, which are provided to the system 20 via the airport configuration data item 70. The calculation assumes an array of taxi route segments are provided from the current position or gate to the estimated runway of departure, where each segment has a start and end vertex. The distance to the next start vertex and surface wind conditions are used as inputs to this calculation, which returns the estimated time of taxiing. These inputs may be manipulated from one or more of the airport configuration data item 70 and the weather data items 53 and 54. The estimated time of departure output from this step is the sum of the total taxi duration and the sum of a constant lineup time, which is the time for the aircraft to align itself for takeoff on the estimated departure runway.

Block 150 for adjusting the ETD for queue delay adjusts departure times to account for same runway separation and wake turbulence separation for successive departures. The calculation utilizes the ETD from block 148, the estimated departure runway from block 166, and the flight schedule data item 42, which includes aircraft size and wake separation.

Block 152 for adjusting the ETD for airport configuration adjusts this ETD output from block 150 by manipulating additional data. This calculation further adjusts departure times to account for arrivals on the same runway and for arrivals and/or previous departures on close parallels or crossing runways. The calculation utilizes the ETD from block 148, the estimated departure runway from block 166, and the flight schedule data item 42, which includes aircraft size. The final adjusted ETD is returned for the respective aircraft at block 154. The returned ETD is added to the runway schedule data item 34 and also added as an input for later steps.

At this point in the algorithm, the estimated target off block times for each departing aircraft can be calculated. Accordingly, an estimated TOBT is the ETD minus taxi duration, lineup time, and queue delay, for example.

Once occupancy information (timing, runway, taxi route, etc.) is estimated for all active arriving and departing flights via process block 80, the algorithm 32 moves to process block 86 for calculating similar information for future arriving and departing flights.

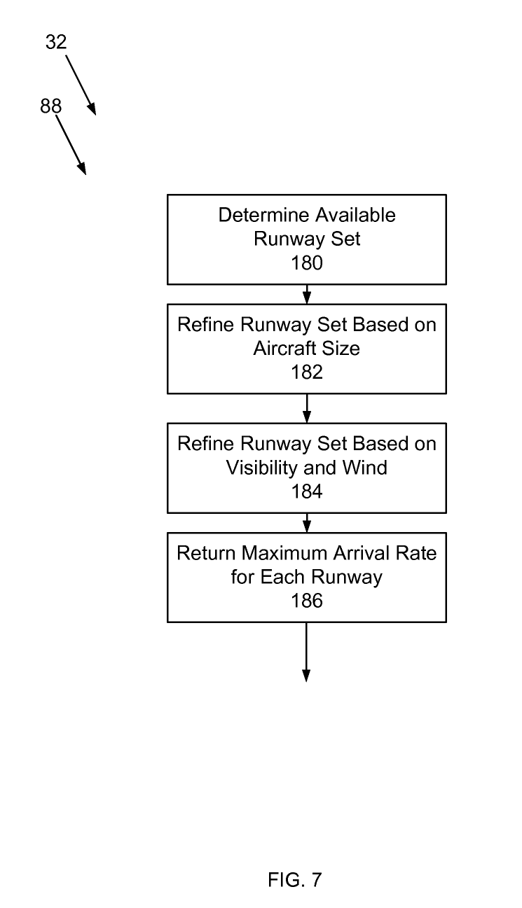

Turning now to FIG. 7, the process block 86 (FIG. 3) begins with a process block 88 for determining the maximum arrival rate of each active runway of the runway grouping. The available runway set is determined based on data from the airport configuration data item 70 (block 180). This runway set is refined based on aircraft size from the flight schedule data item 42 (block 182), and based on current visibility and wind information from the wind data item 53 and RVR data item 54 (184). A maximum arrival rate, such as the maximum number of arrivals per minute, is returned as an output at block 186.

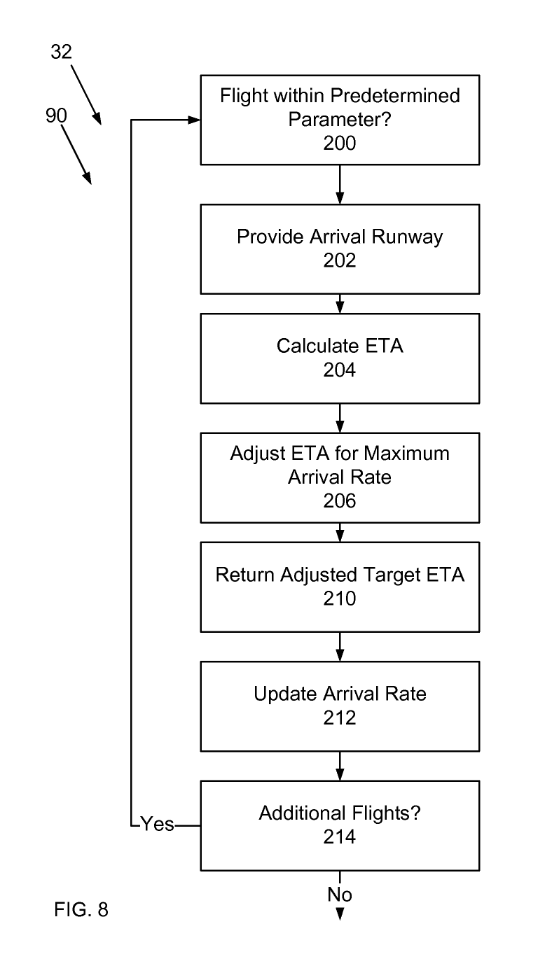

Referring now to FIG. 8, the process of block 90 for estimating occupancy information for each planned future arrival is depicted. The process 90 begins with a sub-process block 200 to determine whether a flight/aircraft is planned for arrival at the runway grouping within the estimated time frame, which in the exemplary embodiment is two hours from the time of initiation of the generation of the current iteration of the runway management data item 34. The flight schedule data item 42 is utilized in this step, and all arriving flights already analyzed in the active arrival flight process block 82 are not analyzed via the process of block 90. The viable arriving flights are then analyzed in order of arrival, from earliest to latest, at each successive loop through the process of block 90.

Accordingly, the algorithm 32 moves to provide an estimated arrival runway (block 202), calculate the estimated time of arrival (ETA) (block 204), adjust the ETA for the maximum arrival rate and to account for preceding arrivals (block 206), and then return the adjusted target ETA (block 210), each of which is further described. Finally, the arrival rate for the respective runway is updated at block 212. Next, the algorithm 32 moves to decision block 214 to determine if there are additional future arriving flights to analyze.

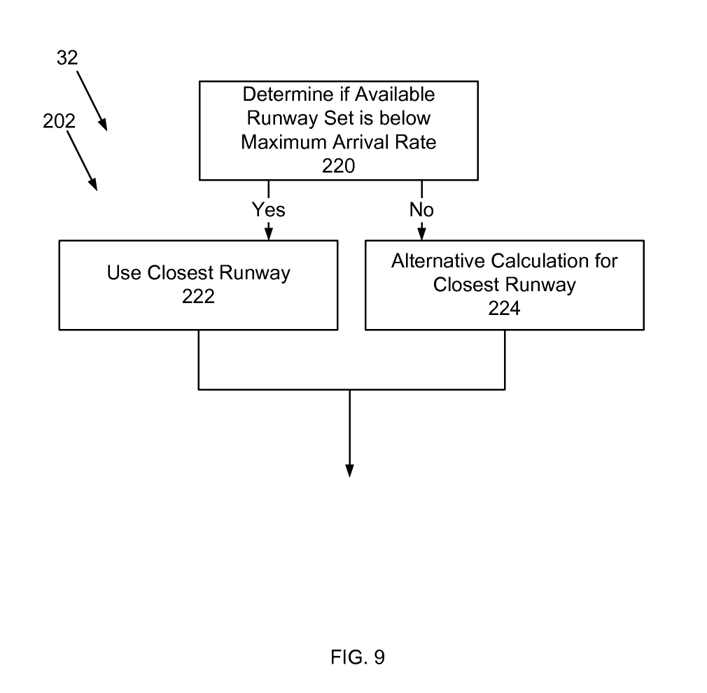

The sub-process of estimating the arrival runway (block 202) is shown at FIG. 9. The available runway set is input from block 180 (sub-process of process block 86). At decision block 220, it is determined whether all of these available runways are below their maximum arrival rate, output from block 88. If the answer is yes, the closest runway is used (block 222), which is based on proximity to the arrival fix of the planned arrival. The arrival fix is data which may be contained in one or more of the flight schedule data item 42, flight plan data item 40, or flight path data item 48. On the other hand if the answer is no, the algorithm moves to block 224, where the most available runway is calculated and output via an alternative calculations. The most available runway is chosen based on an availability capacity, which is calculated as maximum arrival rate (output at block 88) minus adjusted arrival rate. The adjusted arrival rate used for the first future arrival calculation is input from sub-process block 111, and the adjusted arrival rate used for subsequent future arrivals is input from later-calculated sub-process block 214.

The calculation for the respective ETA at the next block 204 includes similar steps to the ETA calculation for an active arriving flight (FIG. 3, block 106). Accordingly, the first step is a calculation of the duration on approach of each flight segment from the aircraft's predicted arrival fix to the runway grouping using the estimated arrival runway provided in block 202. As mentioned with reference to block 202, the predicted arrival fix is obtained from one or more of the flight schedule data item 42, flight plan data item 40 or flight path data item 48.

The calculation assumes an array of flight segments are provided from the arrival fix to the runway threshold. The distance to the next start vertex, headwind, and heading are used as inputs to this calculation, which returns a time duration until landing. These inputs may be manipulated from one or more of the flight path data item 48, including flight paths, and one or more of the weather data items 60 and 62, including wind and other weather data. The estimated time of arrival output from this block 204 is the predicted ETA (obtained from the flight schedule data item 42), minus the average approach duration for flights from the same arrival fix (obtained from the flight path data item 48), plus the sum of the time durations of each flight segment. In other embodiments, another suitable calculation may be used.

The ETA output from the block 204 is adjusted for the arrival rate of the particular estimated runway at block 206. For example, the algorithm 32 may recommend a reduction in approach speed enroute. The ETA is also adjusted to account for previous arrivals. Thus, this calculation adjusts the ETA to account for arrivals on the same runway and for arrivals and/or departures on close parallels or crossing runways in addition to accounting for same runway separation and wake turbulence separation for successive arrivals. The flight schedule data item 42, including aircraft sizes affecting trailing limitations due to wake, and the airport configuration data item 70, including the layout of the runway grouping, are manipulated for this step/block 206.

The adjusted target ETA is returned at block 210. Finally, at block 212, the arrival rate of the estimated runway is also adjusted to account for the addition of the respective future arrival. It is noted that the output occupancy information is input into the respective runway schedule data item 34.

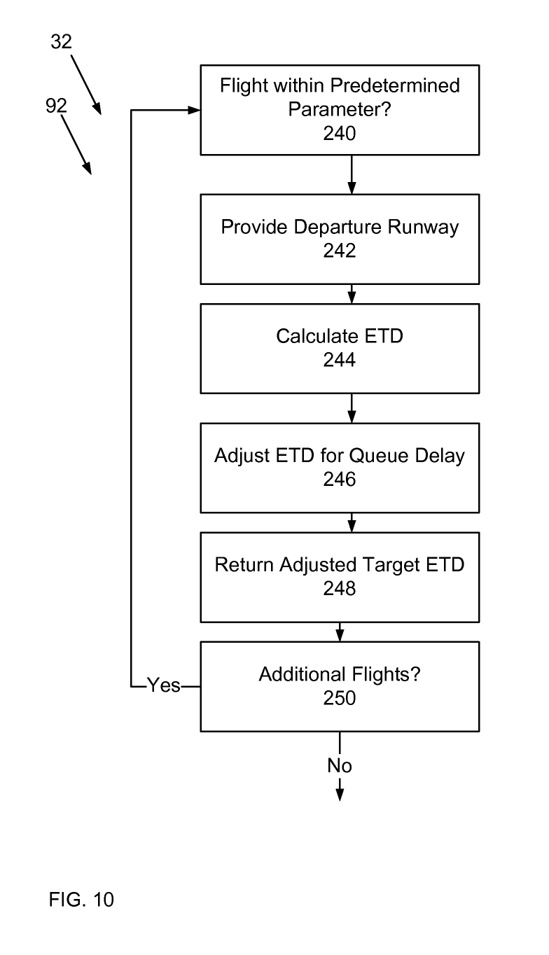

Turning now to FIG. 10, the process of block 92 for estimating occupancy information for each planned future departure is depicted. The process 92 begins with a block 240 to determine whether a flight/aircraft is planned for departure from the runway grouping within the estimated time frame, which in the exemplary embodiment is two hours from the time of initiation of the generation of the current iteration of the runway schedule data item 34. The flight schedule data item 42 is utilized in this step, and all departing flights already analyzed in the active departing flight process block 84 are not analyzed via the process of block 92. The remaining departing flights are then analyzed in order of departure, from earliest to latest, at each successive sub-process step within block 92.

Accordingly, the algorithm 32 moves to provide an estimated departure runway (block 242), calculate the estimated time of departure (ETD) (block 244), adjust the ETD for queue delay, previous arrivals and/or departures, and for queue delay (block 246), and then return the adjusted target ETD (block 248), each of which is further described. Next, the algorithm 32 moves to decision block 250 to determine if there are additional active departing flights to analyze.

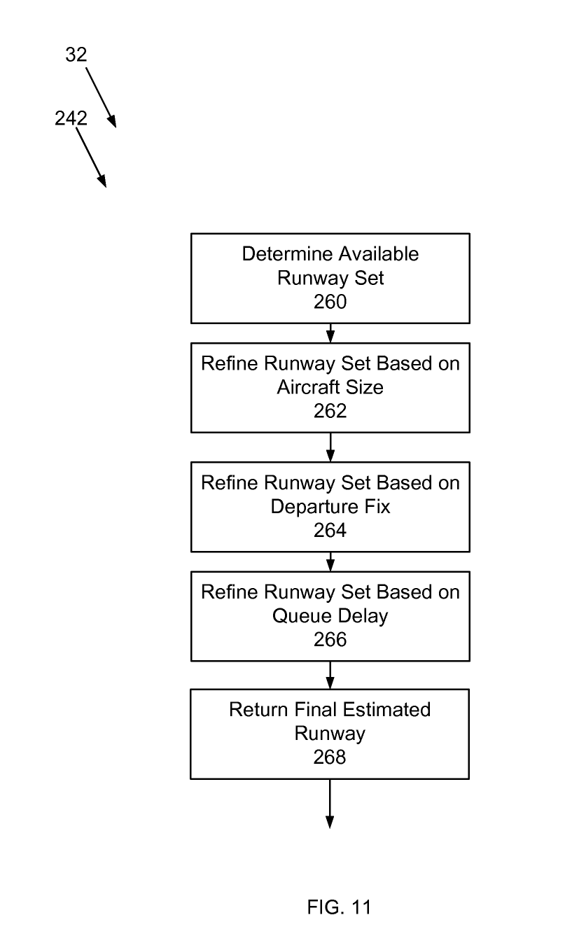

Moving to FIG. 11, the block 242 for estimating the departing runway is further described. First the algorithm 32 looks up active departing runways (block 260) using the airport configuration data item 70. Then, the algorithm 32 refines the runway set based on aircraft size in block 262, using the flight schedule data item 42. The runway set is further refined based on departure fix in block 264, using the flight path data item 48, for example. Finally, the runway set is again refined based on queue delay in block 266, using information from the process of block 84. The most available departure runway is output at block 268.

The block 244 for calculating the ETD begins with a calculation of the taxi duration from the aircraft's gate to its estimated runway provided at block 268. The taxi route is composed of runway segments, which are provided to the system 20 via the airport configuration data item 70. The calculation assumes an array of taxi route segments are provided from the current position or gate to the estimated runway of departure, where each segment has a start and end vertex. The distance to the next start vertex and surface wind conditions are used as inputs to this calculation, which returns the estimated time of taxiing. These inputs may be manipulated from one or more of the airport configuration data item 70 and the weather data items 53, 54, 60 or 62. The estimated time of departure output from this step is the sum of the total taxi duration and the sum of a constant lineup time, which is the time for the aircraft to align itself for takeoff on the estimated departure runway.

Block 246 for adjusting the ETD for queue delay adjusts departure times to account for same runway separation and wake turbulence separation for successive departures. The calculation utilizes the ETD from block 244, the estimated departure runway from block 242, and the flight schedule data item 42, which includes aircraft size. Additionally, ETD is adjusted for airport configuration to account for arrivals on the same runway and for arrivals and/or departures on close parallels or crossing runways. The final adjusted ETD is returned for the respective aircraft at block 248. The returned ETD is added to the runway schedule data item 34 and also added as an input for later steps.

At this point in the algorithm, the estimated target off block times for each future departing aircraft can be calculated, such as when queue delay exceeds a predetermined threshold. Accordingly, an estimated TOBT is the ETD minus taxi duration, lineup time, and queue delay, for example.

Once occupancy information (timing, runway, taxi route, etc.) is estimated for all future arriving and departing flights via process block 86, the algorithm 32 verifies that all active and future occupancy information is entered into the respective runway schedule data item 34, and the algorithm 32 restarts with process block 80.

It is noted that at each step requiring use of an input data item 33, the step utilizes the most recently available particular data item 33 provided to the system 20 and/or received by the system 20. Additionally, in other embodiments, one or more of the above-identified steps may use additional or fewer data items than described for use in the exemplary embodiment. In other embodiments the described processes and sub-processes may each be repeated for all identified respective flights, the entire algorithm may be repeated for each successive identified respective flight after the entire algorithm has been run for the first respective identified flight, or any combination thereof.

In summary, a runway management software 18 for assisting air traffic control personnel by returning an integrated runway schedule data item 34 includes both estimated arrival and departure times and estimated runways for both arrivals and departures of current active and future flights, and on a flight by flight basis. The information is provided in the form of the runway schedule data item 34 which is generated by an algorithm 32 included in the runway management software 18 and coded to a non-transitory computer-readable medium 22. A system 20 for returning the runway schedule data item 34 includes the runway management software 18, the medium 22, and a processor 24 for executing computer code of the software 18.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, stores, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A system for generating a runway schedule data item stored on a non-transitory computer-readable medium, the system comprising:
the non-transitory computer-readable medium;
a processor configured to execute computer code stored on the non-transitory computer-readable medium;
a flight plan data item received by the processor;
a surface tracks data item received by the processor;
a flight schedule data item received by the processor; and
a surface-level weather observation data item received by the processor;
the computer code including an algorithm implementable to calculate estimated arrival and departure times of aircraft arriving and departing from a runway grouping, wherein the algorithm manipulates data stored within each of the flight plan data item, the surface tracks data item, the flight schedule data item, and the surface-level weather observation data item to return a runway schedule data item including a plurality of estimated arrival and departure times of aircraft arriving and departing from the runway grouping.

2. The system of claim 1, further including a display screen communicatively connected to the processor and configured to display the runway schedule returned by the algorithm.

3. The system of claim 1, wherein the algorithm is configured to recalculate the estimated arrival and departure times a first plurality of times per minute.

4. The system of claim 1, wherein the algorithm is configured to return the runway schedule data item a second plurality of times per minute, and wherein the first plurality of times per minutes is greater than the second plurality of times per minute.

5. The system of claim 1, further including an airport configuration data item and an airborne tracks data item received by the processor.

6. The system of claim 1, wherein the algorithm further returns a data item including recommended arrival and departure runways and recommended taxi routes to and from the recommended runways.

7. The system of claim 1, wherein the runway schedule data item includes a plurality of estimated arrival and departure times of aircraft that are scheduled to arrive or depart within a time range extending a predetermined amount of time beyond a time of initiation of generation of the runway schedule data item.

8. A system for sending to a prospective user a runway schedule data item including estimated arrival and departure times of aircraft arriving and departing from a runway grouping, the system comprising:
a non-transitory computer-readable medium, data items encoded on the non-transitory computer-readable medium, computer code encoded on the non-transitory computer-readable medium, and a processor executing the computer code,
the data items including a flight plan data item, a surface tracks data item, and a flight schedule data item; and
the computer code including instructions coded to the non-transitory computer-readable medium and executed by the processor to generate the runway schedule data item, the instructions including:
for each arriving aircraft disposed within a predetermined distance of the runway grouping at the time of initiation of generation of the runway schedule data item, determining a recommended arrival runway and estimated time of arrival to a receiving gate disposed adjacent the runway grouping, and
for each departing aircraft on the runway grouping at the time of the initiation of generation of the runway schedule data item, determining a recommended departure runway and estimated time of departure from the recommended departure runway.

9. The system of claim 8, wherein the instructions of the computer code further include:
for each aircraft scheduled to arrive at the runway grouping within four hours of the initiation of the generation of the runway schedule data item, and with exception to each arriving aircraft disposed within the predetermined distance of the runway grouping at the time of generation of the runway schedule data item, determining a recommended arrival runway and estimated time of arrival to a receiving gate disposed adjacent the runway grouping, and
for each aircraft scheduled to depart from the runway grouping within four hours of the initiation of the generation of the runway schedule data item, and with exception to each departing aircraft on the runway grouping at the time of the initiation of the generation of the runway schedule data item, determining a recommended departure runway and estimated time of departure from a departing gate disposed adjacent the runway grouping.

10. The system of claim 8,
wherein the data items further include an airport configuration data item, and
wherein the instructions of the computer code further include for each aircraft for which an estimated time of arrival or departure is generated, determining a taxi route from or to the runway grouping, respectively.

11. The system of claim 8,
wherein the data items further include an airborne tracks data item, and
wherein the instructions of the computer code further include for each aircraft for which an estimated time of arrival is generated, determining if a reduction in speed instruction should be provided to the respective arriving aircraft.

12. The system of claim 8, wherein the instructions of the computer code further include for each aircraft for which an estimated time of departure is generated, determining the estimated queue delay time and target off block time.

13. The system of claim 8,
wherein the data items further include an airport configuration data item, and
wherein the instructions of the computer code further include for each aircraft for which an estimated time of arrival is generated, recognizing when land and hold short operations are required.

14. The system of claim 8, wherein the instructions of the computer code further include for each aircraft for which an estimated time of departure is generated, determining whether the respective aircraft should hold at an edge of a runway of the runway grouping to avoid wake turbulence.

15. A computer-readable medium having processor-executable instructions implementable to generate a runway schedule data item including estimated arrival and departure times of aircraft arriving and departing from a runway grouping, the instructions comprising:
for each arriving aircraft within a predetermined distance from the runway grouping at the time of initiation of generation of the runway schedule data item
(a) predicting an arrival runway,
(b) calculating an estimated time of arrival, and
(c) adjusting the estimated time of arrival for runway availability due to prior touch downs and/or take offs on and/or adjacent the predicted arrival runway; and
for each departing aircraft on the runway grouping at the time of the initiation of generation of the runway schedule data item
(d) predicting a departure runway,
(e) calculating an estimated time of departure, and
(f) adjusting the estimated time of departure for runway availability due to prior touch downs and/or take offs on and/or adjacent the predicted departure runway.

16. The system of claim 15, wherein the predetermined distance from the runway grouping is 60 NM.

17. The system of claim 15, further including for each aircraft scheduled to arrive at the runway grouping within four hours of the initiation of the generation of the runway schedule data item, and with exception to each arriving aircraft disposed within the predetermined distance of the runway grouping at the time of the initiation of the generation of the runway schedule data item, performing steps (a) through (c).

18. The system of claim 15, further including for each aircraft scheduled to arrive at the runway grouping within four hours of the initiation of the generation of the runway schedule data item, and with exception to each departing aircraft on the runway grouping at the time of the initiation of the generation of the runway schedule data item, performing steps (d) through (f).

19. The system of claim 15, further including receiving a flight plan data item, a surface tracks data item, and a flight schedule data item.

20. The system of claim 15, further including displaying on a display screen the runway schedule data item, and updating the runway schedule data item a plurality of times per minute.
